(19) United States
(12) Patent Application Publication
(10) Pub. No.: US 2025/0080574 A1
(43) Pub. Date: Mar. 6, 2025

(54) SYSTEMS AND METHODS OF AGENT AND AGENTLESS COLLABORATION IN CLOUD INFRASTRUCTURE SECURITY

(71) Applicant: Orca Security Ltd., Tel Aviv-Yafo (IL)

(72) Inventors: Avi SHUA, Tel Aviv-Yafo (IL); Yoav ALON, Tel Aviv-Yafo (IL); Lior DRIHEM, Tel Aviv-Yafo (IL)

(73) Assignee: Orca Security Ltd., Tel Aviv-Yafo (IL)

(21) Appl. No.: 18/593,216

(22) Filed: Mar. 1, 2024

Related U.S. Application Data
(60) Provisional application No. 63/487,857, filed on Mar. 1, 2023.

(51) Int. Cl. H04L 9/40

(52) U.S. Cl. CPC H04L 63/145; H04L 63/1416

(57) ABSTRACT

Embodiments of the present disclosure include a non-transitory computer readable medium that when executed by at least one processor cause the at least one processor to perform operations for dynamic cloud workload protection, the operations comprising: installing an agentless scanning system, the agentless scanning system being configured to scan a cloud server, the cloud server including a network and a memory; detecting, using a cloud provider application program interface (API), an installation of a new workload in the cloud server, the new workload including disks; scanning, using the agentless scanning system, the disks of the new workload; installing an agent on the new workload; monitoring, using the agent, the disks, the network, and the memory of the new workload; generating, using the agent, a notification when an interesting event occurs; scanning, using the agentless scanning system, the cloud server; and generating at least one command to perform one or more of a remediation or a policy update.

### CROSS-REFERENCE TO RELATED APPLICATIONS

This application claims the benefit of priority of U.S. Provisional Application No. 63/487,857, filed Mar. 1, 2023, the contents of which is incorporated herein by reference in its entirety.

### TECHNICAL FIELD

The present disclosure, in some embodiments thereof, relates to new systems and methods for securing cloud infrastructure to help meet compliance mandates, without disrupting business operations in live environments.

### BACKGROUND

The cloud, or cloud computing, refers to servers that are accessed over the Internet and the software and databases that run on said servers. By using cloud computing, users and companies do not have to manage physical servers themselves or run software applications on their own machines. The cloud enables users to access the same files and applications from almost any device, because the computing and storage takes place on servers in a data center instead of locally on the user device.

With the proliferation of cloud computing solutions, security vulnerabilities increase. Cloud Workload Protection (CWP) is the process of continuously monitoring for, and removing, threats from cloud workloads and containers. CWP platforms (CWPP) monitor workloads (e.g., applications, services, capabilities, or specified amounts of work that consume cloud-based resources) in light of possible security vulnerabilities. Non-limiting examples of security vulnerabilities include malware, unpatched software, misconfigurations, missing data encryption, and firewall issues.

In current systems, the two main approaches to CWP are (i) using agents and (ii) using agentless technologies. Agents represent specialized software components that are installed on devices for performing security-related actions, such as, but not limited to, security scanning and reporting, applying software patches, making changes to configurations, and general system monitoring. However, agents may require (a) automation and support for deployment; and (b) maintenance. They can also impact system performance.

Agentless technologies may include technologies referred to as “SideScanning.” “SideScanning,” also referred to as side scanning or side-scanning, may include scanning all cloud assets and their interconnectivity, providing deep and wide visibility into the entire cloud estate, without affecting the assets in any way. SideScanning may cover all major workload types and provide detailed data on compliance issues, log inspection, file integrity monitoring, malware analysis, and telemetry. Additionally, SideScanning may perform some or all of the same actions as agents, as discussed above. In some embodiments, SideScanning may be: (a) performed at designated intervals instead of a real-time basis; and (b) may have limited performance with respect to prevention and auto-remediation actions.

Embodiments of the disclosed cloud workload protection platforms (CWPPs) and/or techniques are directed to overcoming one or more of the shortcomings mentioned above and/or shortcomings in the art.

### SUMMARY

Embodiments of the present disclosure include systems and methods for performing dynamic cloud workload protection. Disclosed embodiments may include installing an agentless scanning system. The agentless scanning system may be configured to scan a cloud server, and the cloud server may include a network and a memory. Using a cloud provider application program interface (API), an installation of a new workload in the cloud server may be detected. The new workload may include disks. Disclosed embodiments may further include using the agentless scanning system to scan the disks of the new workload. An agent may be installed on the new workload. The disks, the network, and the memory of the new workload may be monitored using the agent, and a notification may be generated when an interesting event occurs. Using the agentless scanning system, the cloud server may be scanned. At least one command may be generated, where the at least one command may be configured to perform one or more of a remediation and a policy update.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a schematic block diagram illustrating a network including computerized systems, consistent with disclosed embodiments.

FIG. 2 is a schematic block diagram describing a method of operating a cybersecurity system performing side scanning function, or agentless scanning, to protect against potential vulnerabilities, consistent with disclosed embodiments.

FIG. 3 is a schematic block diagram illustrating a process for dynamic cloud workload protection, consistent with disclosed embodiments.

### DETAILED DESCRIPTION

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. For example, with this detailed description provides a few examples, these implementations are provided as examples only and are not restrictive of the claim concepts that follow or any of the descriptions herein. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, it is to be understood that the present disclosure may be practiced without one or more of these details.

It is intended that one or more aspects of any mechanism may be combined with one or more aspect of any other mechanisms, and such combinations are within the scope of this disclosure.

Aspects of this disclosure may provide technical solutions to challenges associated with cloud cybersecurity. Disclosed embodiments include methods, systems, devices, and computer-readable media. For ease of discussion, a system is described below with the understanding that the disclosed details may equally apply to methods, devices, and computer-readable media.

Embodiments of the present disclosure include technology referred to as “SideScanning.” This technology may also be referred to as “side-scanning” or “side scanning.” This technology may be a type of agentless scanning. In contrast to some existing systems and techniques, embodiments that include agentless scanning or “SideScanning” may provide a distinct advantage because the technology does not necessarily require entering into each workload to inspect data. Rather, some embodiments use an out-of-band process to reach cloud workloads through a runtime storage layer, combining this with metadata gathered from application program interfaces (APIs) provided through a cloud service provider's system, thus providing visibility of cloud environments both at a low level and with context, without the requirement for an agent or network scanner.

Agentless technology, such as SideScanning, may scan file systems of workloads to assess security risks. In some embodiments, SideScanning may be an automated process that is easy to deploy and maintain. Furthermore, in some embodiments, SideScanning may be unintrusive (e.g., will not affect the performance of a workload it is scanning). Furthermore, SideScanning may be installed and run in-account (e.g., in a cloud account or cloud server) or as software as a service (SAAS). However, in some embodiments, SideScanning may be only done on a periodic basis (e.g., not real time) and thus there may be delay before it detects a malicious file being saved to disk. Furthermore, SideScanning may provide limited automatic remediation (e.g., mitigation of a vulnerability of a threat) and little to no prevention (e.g., stopping malicious files from being saved to disk).

Agents may be a piece of software, or a software package, deployed to protect workloads. In some embodiments, agents may be installed on a workload. For example, an agent deployed to protect a container may be installed via sidecar (e.g., a separate container that runs alongside an application container) or eBPF (Berkeley Packet Filter) on the container. Agents may require separate installation for each workload. Agents may provide real time detection of malicious activity as it occurs. Additionally, agents may prevent malicious activity by, for example, blocking a malicious file from being saved to disk or from being executed. Furthermore, agents may provide a wide range of automatic remediation capabilities such as deleting a malware from disk. However, in some embodiments, agents may require automation and support for deployment and maintenance. Agents may also impact system performance.

Embodiments of the present disclosure may provide a novel collaborative method for combining agentless scanning (e.g., SideScanning or side-scanning or side scanning) and agents for real-time detection, prevention, and remediation capabilities in cybersecurity. Embodiments of the present disclosure may reduce processing costs, increase processing speed, and provide a more reactive, or sensitive, cybersecurity system.

The real-time detection, prevention, and remediation may be provided by a cloud workload protection platform (CWPP). A CWPP may be configured to implement a process of keeping workloads that move across different cloud environments secure. It may continuously monitor for, and remove, threats from cloud workloads and containers. A workload may be an application, service, capability, or a specified amount of work that consumes cloud-based resources (e.g., computing or memory power). Examples of a workload may include databases, containers, microservices, virtual machines (VMs), and Hadoop nodes.

As an example of a novel collaborative method for combining agentless scanning and agents, agentless scanning technology may be implemented to periodically scan workloads, or scan workloads at designated intervals. Examples of such designated intervals may be 1 hour, 1 day, 1 week, 1 month, and so forth. It is contemplated that any interval of time may be employed.

Agents may be implemented concurrently with agentless scanning technology. An agent may be associated with one or more workloads in a cloud server. Examples of agents may include a binary that runs on a workload, a kernel module, or a lightweight sandboxed virtual machine (VM) within a kernel (e.g., extended Berkeley Packet Filter, also known as eBPF).

Combined scanning by the agentless scanning technology and agents may be present in three modes or stages: (i) new, (ii) real-time, and (iii) on-demand. It is contemplated that combined scanning may include any number of modes or stages.

The new mode, or new stage, may include detecting a new workload. The new workload may be scanned by the agentless scanning technology, where the agentless scanning technology scans the disk(s) of the new workload. Periodic scans by the agentless scanning technology may be implemented.

The real-time mode, or real-time stage, may include one or more agents scanning new files that are being written to disk in real time. The one or more agents may detect live inbound and outbound traffic to or from workloads. Furthermore, the one or more agents may monitor memory, as the agentless scanning technology may be unable to scan memory due to the agentless scanning technology only having read-only permissions.

The on-demand mode, or on-demand stage, may include triggering the agentless scanning technology to perform scanning when interesting, or specific, events are detected by an agent running on a specific workload. Examples of interesting events (or specific events) may include one or more of a malware written to the disk, a malicious process, or an entity that is trying to exfiltrate sensitive data.

Remediation may be performed when an agent scan and/or an agentless scanning technology scan results in a finding. Examples of a finding may include one or more of: discovery of a malware written to the disk, discovery of a malicious process, or discovery of an entity that is trying to exfiltrate sensitive data. As discussed above, agentless scanning technology may be limited in its ability to remediate findings due to its read-only permissions. Thus, agents may perform active remediation actions such as deleting malicious files from disks and changing workload configurations.

Prevention techniques may be implemented after an agent scan and/or an agentless scanning technology scan results in a finding and the finding is remediated. As agentless scanning technologies are detection mechanisms, they may not support prevention. Thus, agents may prevent malicious activity by preventing malware from being saved to disk and/or by blocking inbound and/or outbound traffic that may cause damage to the workload and/or cloud server.

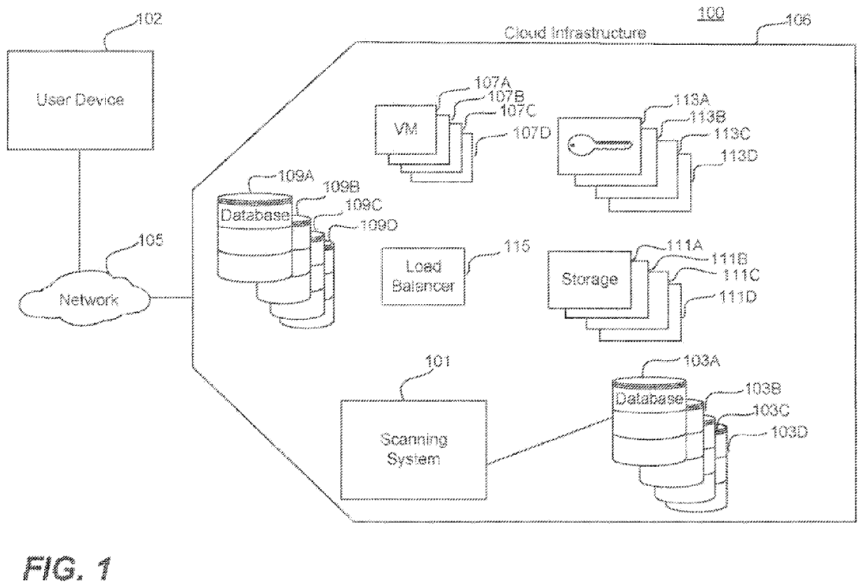

FIG. 1 is a schematic block diagram 100 illustrating an exemplary embodiment of a network including computerized systems, consistent with the disclosed embodiments. Diagram 100 includes user device 102, network 105, and cloud infrastructure 106.

Cloud infrastructure 106 includes scanning system 101, databases 103A-103D, virtual machines 107A-107D, databases 109A-109D, storage 111A-111D, keystores 113A-113D, and load balancer 115. While particular numbers and arrangements of devices, systems, and connections, are depicted in exemplary FIG. 1, in some embodiments, each of the devices, systems, or connections may be omitted, duplicated, or modified. For example, in some embodiments, databases 109A-109D may exist as only a single database; in other embodiments, cloud infrastructure 106 may exist as one or more distinct or combined infrastructures (e.g., operated by the same or different cloud services). In some embodiments, scanning system 101 and/or databases 103A-103D may be part of cloud infrastructure 106 (and may be connected to the various other systems and devices in cloud infrastructure 106); in other embodiments, scanning system 101 and/or databases 103A-103D may be separate from cloud infrastructure 106 (e.g., connected to the systems and devices in cloud infrastructure 106 through network 105).

Scanning system 101, in some embodiments, may include one or more computer systems. Each of the one or more computer systems may include memory storing instructions and at least one CPU configured to execute those instructions to perform operations as discussed herein. In some embodiments, the instructions cause the CPU to perform scanning operations. In some embodiments, scanning system 101 may perform a scanning operation on one or more workloads (e.g., systems, devices, resources, etc.) in cloud infrastructure 106.

User device 102, in some embodiments, may include a mechanism operated by a user to control scanning system 101. For example, in some embodiments, user device 102 may be any of a personal computer, a server, a thin client, a tablet, a personal digital assistant, a smartphone, a kiosk, or any other mechanism enabling data input. User device 102 may be operated to instantiate functionality, access data, or otherwise interact with scanning system 101 via network 105, as described herein.

Databases 103A-103D include data stores for use by scanning system 101. In some embodiments, one or more of databases 103A-103D may be implemented as a NoSQL database, a relational database, a cloud database, a columnar database, a wide column database, a key-value database, an object-oriented database, a hierarchical database, or any other kind of database. In some embodiments, one or more of databases 103A-103D may be implemented as flat file stores, data stores, or other non-database storage systems. In some embodiments, databases 103A-103D may be implemented using one or more of ElasticCache, ElasticSearch, DocumentDb, DynamoDB, Neptune, RDS, Aurora, Redshift clusters, Kafka clusters, or EC2 instances.

Network 105 may be implemented as one or more interconnected data networks. For example, network 105 may include one or more of any type of network (including infrastructure) that provides communications, exchanges information, and/or facilitates the exchange of information, such as the Internet, a Local Area Network, a near field communication (NFC) network, or other suitable connection(s) that enables the sending and receiving of information between the components of system 100. Network 105 may be implemented using wireless connections, wired connections, or both. In some embodiments, one or more components of system 100 can communicate through network 105. In some embodiments, one or more components of system 100 may communicate directly through one or more dedicated communication links. While particular devices and systems are shown as connected to network 105, in some embodiments, more or fewer devices and systems may be connected to network 105.

Cloud infrastructure 106 may be implemented as a set of devices and systems offered by a single cloud service provider. For example, cloud infrastructure 106 may comprise devices and systems that are part of Amazon Web Services, Microsoft Azure, Google Cloud Platform, IBM Cloud, Alibaba Cloud, or any other cloud platform provider. In some embodiments, one or more of the devices and systems in cloud infrastructure may require authentication or other identity validation for access. For example, to access virtual machine 107A, a user may be required to enter a password or provide a key. Systems (e.g., scanning system 101 or user device 102) may administer or interact with cloud infrastructure 106 using a cloud service provider's system (not pictured).

Virtual machines 107A-107D may include one or more devices and systems that implement a virtualized/emulated version of a computer. A virtual machine may be implemented as an emulated version of a computer—including an operating system, memory, storage, graphics processing—such that it can be indistinguishable from a standard (non-virtual) machine to a running program. A computer system, referred to as a “host,” may operate virtual machines 107A-107D, referred to as “guests,” by dividing the resources of the host between the virtual machines such that each virtual machine is isolated from one another. This means that in some embodiments, one virtual machine, and the operating system(s) and application(s) running thereon, is only able to access the resources that are allocated to that virtual machine and cannot access resources allocated to other virtual machines. For example, if a host has 32 gigabytes of random access memory (RAM), and is hosting three virtual machines, the host may segment 8 gigabytes of RAM to each virtual machine such that each virtual machine may only access data in that 8 gigabytes of RAM and not any of the other 24 gigabytes. Examples of commercial virtual machine software and services include VMWare Workstation, VMWare Server, VMWare ESXi, VirtualBox, Parallels Desktop, Parallels RAS, Amazon Machine Image, Amazon ECS, Kubernetes, Microsoft Hyper-V, and Xen.

Databases 109A-109D may include data stores for use by devices and systems in cloud infrastructure 106. In some embodiments, one or more of databases 109A-109D may be implemented as a NoSQL database, a relational database, a cloud database, a columnar database, a wide column database, a key-value database, an object-oriented database, a hierarchical database, or any other kind of database. In some embodiments, one or more of databases 109A-109D may be implemented as flat file stores, data stores, or other non-database storage systems. In some embodiments, databases 109A-109D may be implemented using one or more of ElasticCache, ElasticSearch, DocumentDb, DynamoDB, Neptune, RDS, Aurora, Redshift clusters, Kafka clusters, or EC2 instances. Databases 109A-109D may store data usable by devices or systems in cloud infrastructure 106. The data, in some embodiments, may include e-commerce data (e.g., shipments, orders, inventory), media data (e.g., pictures, movies, streaming data), financial data (e.g., banking data, investment data), or other data.

Storage 111A-111D may include storage systems for use by devices and systems in cloud infrastructure 106. In some embodiments, one or more of storage 111A-111D may be implemented as a hard drive, a RAID array, flash memory, optical storage, or any other kind of storage. Each of 111A-111D may include one or more filesystems (e.g., Amazon Elastic File System, GlusterFS, Google File System, Hadoop Distributed File System, OpenZFS, S3, Elastic Block Storage).

In some embodiments, systems and devices of cloud infrastructure 106 may use databases 109A-109D to store data that is accessed frequently (where, for example, access is required within a few milliseconds), and may use storage 111A-111D to store data that is accessed less frequently (where, for example, access is required within a few minutes or hours).

Keystores 113A-113D may include systems storing keys for accessing data and functionality. For example, to access certain data or systems, a system may require the use of passwords or keys in keystores 113A-113D for authentication. The data and functionality that the keys grant access to may be part of cloud infrastructure 106 or may be separate from cloud infrastructure 106. For example, keystores 113A-113D may include systems that store public and private keys (e.g., for use via SSH), may store passwords (e.g., login information for websites or programs), may store tokens (e.g., one-time passcodes), or the like. In some embodiments, keystores 113A-113D may be implemented as one or more of Amazon Web Services KMS, Azure Key Vault, or Google KMS.

Load balancer 115 may include one or more systems that balance incoming requests between the different systems and devices of cloud infrastructure 106. For example, load balancer 115 may be configured to determine usage (e.g., processor load, used storage capacity) of systems or devices in cloud infrastructure 106 to assist in determining where to route an incoming request from network 105 to store data, perform processing, or retrieve data.

Load balancer 115 may be configured to receive an incoming request from user device 102. Upon receipt of the request, load balancer 115 may consult a data store (part of or separate from load balancer 115; not pictured) to determine usage or forecasted usage of various systems or devices in cloud infrastructure 106 and may forward the request to the systems or devices having the lowest usage or forecasted usage.

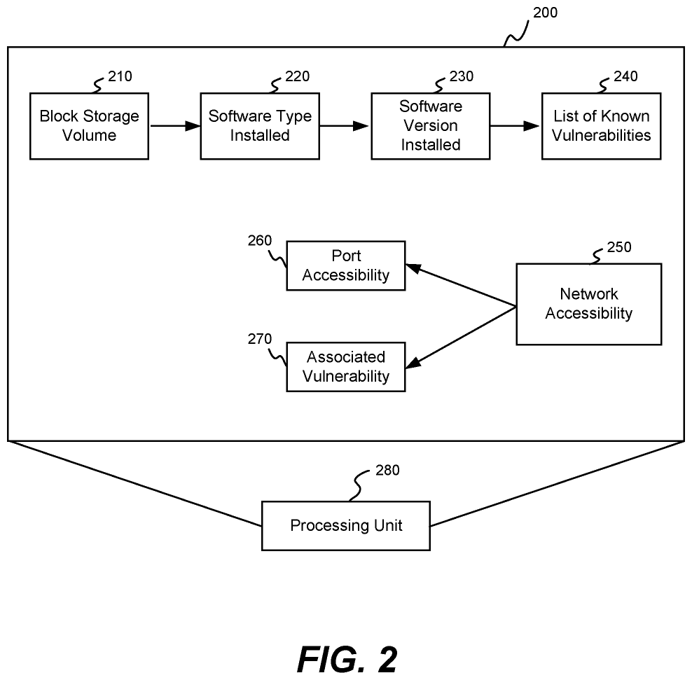

FIG. 2 of the disclosed embodiments describes a system of operating a cybersecurity system performing agentless scanning, or a side scanning (SideScanning) function, to protect against potential vulnerabilities. A processor (or processing) unit 280 may be configured to perform the method. When initiated either manually or automatically, processor unit 280 may be communicatively connected with a cloud provider API 200 to initiate a cybersecurity function as disclosed above. Contained digitally on a memory device and accessed by a cloud provider API 200 is a series of block storage volumes 210. Processor unit 280 may be capable of performing a vertical and horizontal scan for network access or security information of a block storage volume 210 to detect potential vulnerabilities to the block storage volume 210 or any processing unit 280 designed to access said block storage volume 210.

Based on the accessed block storage volume 210, processor unit 280, with the disclosed embodiments of a cybersecurity system, may perform an identification of the type of software installed 220 connected with block storage volume 210. Following identification of the type of software installed 220, the processor unit may then identify an installed version 230 of said installed software 220 for a version comprised of a unique identifier based on a combination of letters, numbers, or similar unique identifiers.

Upon recognition of an installed software version 230 of the installed software 220, processor unit 280, with some embodiments of the disclosed scanning system 101, may provide a list of known vulnerabilities 240 for review by said scanning system 101 and/or its end user and maintainer of said block storage volumes 210. Based on the list of known vulnerabilities 240, embodiments of the disclosed scanning system 101 or its end user may identify one or more ports of accessibility to said block storage volume 210 that may be accessed by a known, associated vulnerability 270 from listed vulnerabilities 240 to determine an avenue for potential vulnerability 270 to access and infiltrate block storage volume 210.

In some embodiments, a cyber security scanning system for a cloud environment 101 may include a processor (e.g., processor unit 280) to operate said system. This processor unit 280 may include central processing units and other similar computer-enabling equipment for processing and executing commands based on the information inputted to said system. The processor unit 280 may be communicatively connected to a computer network or series of networks to accomplish said cyber security function.

As an example embodiment, a processor unit 280 may be configured to use a cloud-provider API that may communicate with one or more specified computer-readable media across a digital network. This can be accomplished through internet protocols, internet control message protocols, transmission control protocols, or user datagram protocols. Cloud provider API 200 may be one of several forms of middleware, interface, middle layer, or other systems of interfacing applications. A processor 280 may be one or more computer processing units, central processing unit, server, microcomputer, mainframe, and any other manifestation of digital computing.

Further to one of several possible embodiments, a cloud-provider API 200 may be configured to access a block-storage volume 210 of a workload maintained in a cloud-storage environment. This may be accomplished through a system of computer-readable media communicatively connected. Said block-storage volume 210 may be contained on a Storage Area Network (SAN) or similar cloud-based memory storage environment. The block storage volume 210 may be contained in smaller storage volumes with an associated identifier unique to that portion of said block storage volume 210. In some embodiments, the block-storage volume 210 of a workload may have multiple paths for the storage volume to be reaggregated and retrieved quickly.

Among several embodiments, a scanning system 101 may comprise a system for identifying an installed software application in the accessed block-storage volume 210. This identification of installed software may be accomplished by accessing installed software 220 files through signature verification, root license, or authorized user lists. The installed software 220 may be located and identified within applications such as file storage, database storage, and virtual machine file system volumes. The identification of said installed software application 230 may be processed, analyzed, and communicated to the scanning system 101 for processing, cataloging, and protection through encryption and various methods of layered cyber defense.

Further, the scanning system 101 described herein may include functionality to analyze installed software applications to determine the associated software version. The software application version 230 may identify the software version based on unique version name, unique version number, and may be based on unique states of the currently installed computer software 220.

One of many embodiments disclosed above may include the scanning system 101 having the ability to access a data structure of known software vulnerabilities 240 for a plurality of versions of software applications. The known software vulnerabilities 240 may include, among others, missing data encryption, OS command injection, SQL injection, buffer overflow, missing authentication, missing authorization, unrestricted upload of dangerous file types, reliance on untrusted inputs in a security decision, cross-site scripting and forgery, download of codes without integrity checks, broken algorithms, URL redirection, path traversal, software bugs, weak passwords, and previously infected software. The scanning system 101 may be able to access and identify software vulnerabilities for mitigation, rectification, correction, and fortification.

In one embodiment, a cybersecurity system may also perform scanning according to scanning system 101 by performing a lookup of the identified installed software version 230 in the data structure to identify known vulnerabilities 240. This function can be performed by the scanning system 101 of FIG. 1 by performing a query of the installed software 220 for unique version number or designator and comparing to, amongst many things, a set of likely or potential vulnerabilities to that software version for potential deficiencies or cybersecurity threats known or suspected to similar software types and versions. This query may be performed according to a predetermined set of values, to include previously identified unique version numbers or designators that may contain the known list of previously identified vulnerabilities.

Among many embodiments, some embodiments of the disclosed scanning system 101 may query the cloud provider API 200 to determine network accessibility information 250 related to the workload. In order to accomplish this query of the cloud provider API 200, the scanning system 101 may involve an index of search results and display of said search results, followed by processing and grouping search results. Network accessibility information 250 may include connection quality, alternative paths between nodes in a network, and the ability to avoid blockage in said networks. The workloads associated with this query may include applications, services, capabilities, and specific processes such as virtual machines, databases, containers, or Hadoop nodes, among others.

If the system detects a vulnerable application 270, one embodiment may identify one or more ports on which said vulnerable application is accessible. In one of several embodiments, the scanning system 101 may detect a vulnerable application in one or more computation processes. In another embodiment, the cybersecurity system may perform a network accessibility query in a separate process. Further, a disclosed embodiment may perform these separate functions in subsequent and sequential steps of the same process. A person having skill would understand that an authorized user or an authorized scanning system 101 can perform these functions concurrently and subsequently by an authorized user or an authorized cybersecurity system while performing the same function as the disclosed embodiment.

Upon gathering network accessibility information and the identified port to identify one or more vulnerabilities susceptible to attack from outside the workload, a disclosed embodiment would have the functionality to perform processes to gather, display, and mitigate a discovered vulnerability in order to minimize the likelihood and effectiveness of a cyber threat outside of and attempting to access a workload through a known or previously encountered type of cyber threat. This functionality may include collecting and organizing the vulnerabilities according to type or category of vulnerability, displaying the gathered data for an end user or maintainer, and implementing security features automatically or manually by a user or maintainer such as security patches, password or passcode changes and suggestions for users to do the same, and malicious code eradication.

As one of several possible embodiments, the scanning system 101 may also, upon identification of one or more vulnerabilities, implement remedial actions, or remediation, via one or more processors. Remedial actions may include, among other things, notification to an end user of an identified threat, compensation through a revised security code to mitigate the potential threat, publication of the identified threat and vulnerability in a log or record of detected vulnerabilities, and communication of the sensed vulnerability and threat to a server operator or maintainer to fortify the protections of workloads existing on similar environments.

In a similar embodiment to above, the remedial measure may include transmission of an alert to a device associated with an administrator. The alert may be, amongst others, written, auditory, and visual for processing and use by an administrator of said scanning system 101. Said administrator may take action based on the received alert, to include eliminating the cyber threat through mitigation measures, change in cybersecurity posture, or removing the workload from the cybersecurity threat environment.

In another embodiment, a query of the cloud provider API 200 to determine network accessibility information related to the workload may be performed by at least one processor 280 configured to examine data sources associated with the workload. The data examined may include user data, system processing data, accessibility data, clock cycles, storage input/output, or similar data processors. A query of the cloud provider API 200 may be automated or manually-initiated. Based on the said query, the network accessibility information 250 related to the workload may change based on the data sources associated with said workload.

In the above processor and similar embodiments, further configuration may include a process to determine network accessibility information 250 based on the examined data sources. The examined data sources may include various cloud-based workloads, internet protocols, transmission communication protocols, or other methods and systems of memory and data storage.

In some embodiments, network accessibility information 250 includes at least one of: data from an external data source, cloud provider information, or at least one network capture log. These embodiments of an external data source may include data from the operating environment of the cloud-based environment, an external operating system for a computer processing unit 280, or other similar computer readable media. Cloud provider information may further include information that may identify the network accessibility information 250 vertically or horizontally to fully describe the associated workload. Network capture logs may be automated or manually updated to include possible vulnerabilities 270 and threats to the cloud-based storage medium.

Further, the disclosed embodiments may include an installed software application 230, with at least one processor 280 configured to extract data from at least one of operating system packages, libraries, or program language libraries. This data may be extracted through a system query, random access algorithm, or similar automated process. Operating system packages may include systems operable on Microsoft, Apple, Linux, and similar operating systems. Libraries may consist of a series of files, folders, and databases of information stored on one of any indexed data repositories. A program language library may contain several program languages including but not limited to Javascript, Swift, Scala, Go, Python, Elm, Ruby, C #, C++ and other similar sources of software code.

Furthermore, in some embodiments, a scanning system 101 may also include a processor 280, configured to identify installed software application 220 based on the extracted data. The processor 280 may perform only this function or this function among many to accomplish the layered cybersecurity defense described herein in embodiments of the disclosed cloud-based security environments. The identification of installed software by said processor may include identifying the software by unique version number or designator, recognized source code, metadata associated with the installed software application files, or similar software-identifying information.

One embodiment may include an additional function wherein the installed software application 220 that has been identified includes one or more scripts. These scripts may be processed through various computer readable languages to include Javascript, C #, C++ and other forms of computer code.

One embodiment contemplated by the disclosed scanning system 101 may also include data structure including aggregated vulnerability data 240. This aggregated vulnerability data 240 may be compiled by an end user or maintainer from within the cloud-based environment of the current data structure as well as compilation from similar data sets and aggregation of common threats to data structures likely to experience similar vulnerabilities. This aggregation of vulnerability data 240 may be contained within the data structure and it may be collectively aggregated to provide for a more robust and layered cybersecurity defense posture.

In some embodiments of the disclosed scanning system 101, the aggregated vulnerability data 240 may include data from one or more third-party vendors. These vendors may include operators of the cloud-based server environment, providers of networking and internet communication, methods of layered authentication, and other similar providers of services directly related and in communication with the cloud-based cybersecurity system.

As an additional exemplary embodiment, the aggregated vulnerability data 240 may include data collected by a scanner. This scanner may involve use of continuous or periodic monitoring of the workload. The scanner may perform security screenings of the various workloads vertically or horizontally to identify network identification information, port accessibility, and associated vulnerabilities. Any scan performed may be communicated to the scanning system 101 that may be responsible for performing and logging the results of the scan and may be able to initiate follow-on processes and protocols to protect the data contained in the workload that is the subject of scanning.

An embodiment of the disclosed scanning system 101 may also include aggregated vulnerability data 240 that may include at least one of an advisory, an exploit, a security announcement, or a known bug. An advisory may include notification to a system maintainer or user of the potential vulnerability, may log notice of the advisory, and may recommend possible user or maintainer actions to potentially address said advisory. An exploit may further consist of an automated system response designed to take advantage of the sensed vulnerability data. The exploit can be further reflected in the aggregated vulnerability data and protocols can be written into the cybersecurity infrastructure to prevent said exploit from gaining access and permissions to unauthorized areas of the workload storage environment.

A person having ordinary skill in the art would appreciate the above-described embodiments are among many potential embodiments, to include a method of operating a scanning system 101 similar to the one described above. Some embodiments of the present disclosure contemplate this method to be accomplished through manual user operation, automated computer processes, or similar manners of operation. These manners of operation and those contemplated similar to them would allow the scanning system 101 described and disclosed to execute its operations as the system above describes.

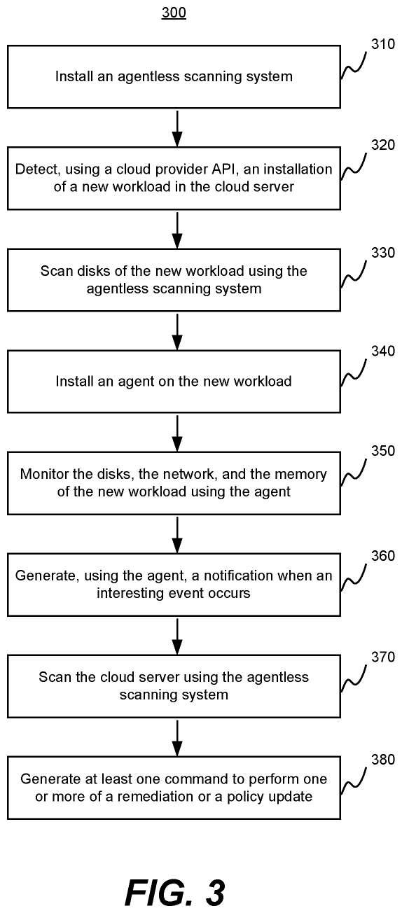

FIG. 3 is a schematic block diagram illustrating a process for dynamic cloud workload protection 300, consistent with disclosed embodiments. The process 300 may include installing an agentless scanning system, such as scanning system 101 as described with respect to FIG. 2, as shown in step 310. In some embodiments, the agentless scanning system may be installed in a cloud account or a cloud server. In other embodiments, the agentless scanning system may be installed or run as a software as a service (SAAS). The agentless scanning system may be configured to scan a cloud server, and the cloud server may include a network and a memory, such as, for example, the network 105 and storage 111A-111D of FIG. 1. As shown in step 320, the process 300 may involve detecting an installation of a new workload in the cloud server using a cloud provider application programming interface (API) 200. The process 300 may further include, as shown in step 330, scanning disks of the new workload using the agentless scanning system. The scanning may include the method of performing side scanning discussed with respect to FIG. 2.

The process 300 may also include installing an agent on the new workload, as shown in step 340. In some embodiments, the agent may be specific to the type of cloud workload it is installed on (e.g., virtual machine, database, container, application). Furthermore, the installation of the agent on the workload may be performed by one or more of an automation or an end user. The cloud server may send commands to the agent and receive information from the agent regarding the workload that the agent is installed on. As shown in step 350, the process 300 may include monitoring the disks, the network, and the memory of the workload using the agent. In some embodiments, the monitoring may include analyzing read/write actions. The process 300 may also include, as shown in step 360, generating a notification when an interesting event occurs. The process 300 may involve using the agent in the generation of the notification. Further, in some embodiments, the interesting event may be one or more of a malware written to the disk, a malicious process, an entity that is trying to exfiltrate sensitive data, or any indication of a breach of data or cybersecurity.

In some embodiments, the process 300 may include scanning the cloud server using the agentless scanning system, as shown in step 370. Furthermore, in some embodiments, the scanning of the cloud server may be triggered by the generated notification of step 360.

The process 300 may further include generating at least one command to perform one or more of a remediation or a policy update, as shown in step 380. The at least one command may be generated by the backend of the cloud server. As used herein, a remediation may pertain to one or more of (i) rectifying or stopping a portion or all of damage done to one or more of the disks, the network, and the memory by entities associated with the interesting event, or (ii) performing a remedial action. As described above, a remedial action may include, among other things, notification to an end user of an identified threat, compensation through a revised security code to mitigate the potential threat, publication of the identified threat and vulnerability in a log or record of detected vulnerabilities, and communication of the sensed vulnerability and threat to a server operator or maintainer to fortify the protections of workloads existing on similar environments. Furthermore, as used herein, a policy update may pertain to an introduction of or change in a set of instructions for or requirements associated with a cybersecurity system.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor, cause the at least one processor to perform a method. Non-transitory computer readable medium may include any medium capable of storing data in any memory in a way that may be read by any computing device with a processor to carry out methods or any other instructions stored in the memory. The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine having any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

Memory employed herein may include a Random Access Memory (RAM), a Read-Only Memory (ROM), a hard disk, an optical disk, a magnetic medium, a flash memory, other permanent, fixed, volatile or non-volatile memory, or any other mechanism capable of storing instructions. The memory may include one or more separate storage devices collocated or disbursed, capable of storing data structures, instructions, or any other data. The memory may further include a memory portion containing instructions for the processor to execute. The memory may also be used as a working scratch pad for the processors or as a temporary storage.

Some embodiments may involve at least one processor. A processor may be any physical device or group of devices having electric circuitry that performs a logical operation on input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory.

In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact.

Consistent with the present disclosure, disclosed embodiments may involve a network. A network may constitute any type of physical or wireless computer networking arrangement used to exchange data. For example, a network may be the Internet, a private data network, a virtual private network using a public network, a Wi-Fi network, a LAN or WAN network, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

Certain embodiments disclosed herein may also include a computing device for cloud cybersecurity, the computing device may include processing circuitry communicatively connected to a network interface and to a memory, wherein the memory contains instructions to be executed. The computing devices may be devices such as mobile devices, desktops, laptops, tablets, or any other devices capable of processing data. Such computing devices may include a display such as an LED display, augmented reality (AR), virtual reality (VR) display.

“Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

What is claimed is:

1. A non-transitory computer readable medium containing instructions that when executed by at least one processor cause the at least one processor to perform operations for dynamic cloud workload protection, the operations comprising:
installing an agentless scanning system, the agentless scanning system being configured to scan a cloud server, the cloud server including a network and a memory;
detecting, using a cloud provider application program interface (API), an installation of a new workload in the cloud server, the new workload including disks;
scanning, using the agentless scanning system, the disks of the new workload;
installing an agent on the new workload;
monitoring, using the agent, the disks, the network, and the memory of the new workload;
generating, using the agent, a notification when an interesting event occurs;
scanning, using the agentless scanning system, the cloud server; and
generating at least one command to perform one or more of a remediation and a policy update.

2. The non-transitory computer readable medium of claim 1, wherein the installation of the agent on the new workload is performed by an automation or an end user.

3. The non-transitory computer readable medium of claim 1, wherein the monitoring includes analyzing read/write actions.

4. The non-transitory computer readable medium of claim 1, wherein the interesting event is one or more of a malware written to the disk, a malicious process, and an entity that is trying to exfiltrate sensitive data.

5. The non-transitory computer readable medium of claim 1, wherein the scanning of the cloud server is triggered by the generated notification.

6. The non-transitory computer readable medium of claim 1, wherein the remediation includes a remediation of new security issues.

7. The non-transitory computer readable of claim 1, wherein the policy update includes a policy update that prevents future security issues.

8. A method for performing dynamic cloud workload protection, the method comprising:
installing an agentless scanning system, the agentless scanning system being configured to scan a cloud server, the cloud server including a network and a memory;
detecting, using a cloud provider application programming interface (API), an installation of a new workload in the cloud server, the new workload including disks;
scanning, using the agentless scanning system, the disks of the new workload;
installing an agent on the new workload;
monitoring, using the agent, the disks, the network, and the memory of the new workload;
generating, using the agent, a notification when an interesting event occurs;
scanning, using the agentless scanning system, the cloud server; and
generating at least one command to perform one or more of a remediation and a policy update.

9. The method of claim 8, wherein the installation of the agent on the new workload is performed by an automation or an end user.

10. The method of claim 8, wherein the monitoring includes analyzing read/write actions.

11. The method of claim 8, wherein the interesting event is one or more of a malware written to the disk, a malicious process, and an entity that is trying to exfiltrate sensitive data.

12. The method of claim 8, wherein the scanning the cloud server is triggered by the generated notification.

13. The method of claim 8, wherein the remediation includes a remediation of new security issues.

14. The method of claim 8, wherein the policy update includes a policy update that prevents future security issues.

15. A system for performing dynamic cloud workload protection, the system comprising:
at least one processor configured to:
install an agentless scanning system, the agentless scanning system being configured to scan a cloud server, the cloud server including a network and a memory;
detect, using a cloud provider application program interface (API), an installation of a new workload in the cloud server, the new workload including disks;
scan, using the agentless scanning system, the disks of the new workload;
install an agent on the new workload;
monitor, using the agent, the disks, the network, and the memory of the new workload;
generate, using the agent, a notification when an interesting event occurs;
scan, using the agentless scanning system, the cloud server; and
generate at least one command to perform one or more of a remediation and a policy update.

16. The system of claim 15, wherein the installation of the agent on the new workload is performed by an automation or an end user.

17. The system of claim 15, wherein the monitoring includes analyzing read/write actions.

18. The system of claim 15, wherein the interesting event is one or more of a malware written to the disk, a malicious process, and an entity that is trying to exfiltrate sensitive data.

19. The system of claim 15, wherein the scanning of the cloud server is triggered by the generated notification.

20. The system of claim 15, wherein the remediation includes a remediation of new security issues.
